(19) United States
(12) Patent Application Publication
(10) Pub. No.: US 2023/0116923 A1
(43) Pub. Date: Apr. 20, 2023

(54) Sample Container Handling System

(71) Applicant: MLS MIKROWELLEN-LABOR-SYSTEME GMBH, Leutkirch (DE)

(72) Inventor: Werner Lautenschläger, Leutkirch (DE)

(21) Appl. No.: 17/969,132

(22) Filed: Oct. 19, 2022

(30) Foreign Application Priority Data
Oct. 20, 2021 (DE) 20 2021 105 714.9

(51) Int. Cl. G01N 35/04

(52) U.S. Cl. CPC G01N 35/04; G01N 2035/0429

(57) ABSTRACT

The present invention relates to a sample container handling system (1), having a sample container receptacle (2) and a support element (20). The sample container receptacle (2) in turn has: holding structures (4, 5) which are each configured to hold a respective sample container (3) and which are disposed about a rotation axis (6), and a base (7) having a support region (8) for supporting the sample containers (3) held by way of the holding structures (4, 5), wherein the base (7) furthermore has a side (10) that faces away from the support region (8) and at least one through opening (11) which from this side (10) extends to the support region (8). The support element (20) is connectable to the base (7) of the sample container receptacle (2) in such a manner so as to receive the latter, wherein the support element (20) has at least one protrusion (25, 26, 27) which, when the support element (20) receives the sample container receptacle (2), extends through the at least one through opening (11) and for lifting one or more sample containers (3) projects from the support region (8). The invention furthermore relates to a system having the sample container handling system (1) and a pressure container having a reaction chamber in which the sample container receptacle (2) is able to be received or is received.

### FIELD OF THE INVENTION

The invention relates to a sample container handling system and to a system having a sample container handling system of this type and a pressure container having a reaction chamber as a pressurized chamber for initiating and/or promoting chemical and/or physical pressurized reactions of samples received in the reaction chamber.

### BACKGROUND OF THE INVENTION

When carrying out pressurized reactions on samples, handling of these samples before and/or after the respective pressurized reaction is required. The samples here are received in a plurality of sample containers, wherein the sample containers in turn are held in a sample container receptacle. The sample containers are received so as to lie close to one another in the sample container receptacle. As a result, a reaction chamber of a pressure container can be populated with a particularly large number of sample containers. Moreover, a particularly large number of sample containers can be handled as a result.

A disadvantage of a close-together arrangement of this type is the inadequate level of safety in the handling of the individual sample containers. The individual sample containers are often filled with hazardous or harmful samples such as, for example, chemicals or acids. As a result of the minor spacing between adjacent sample containers, there is thus the risk of undesirable contact such as, for example, skin contact with the respective sample taking place when handling the sample containers.

For example, it may arise that the sample escapes or spills from the corresponding sample container during the handling of the latter and thereafter physically and/or chemically undesirably affects a surface such as, for example, skin. Consequently, a disadvantage of the sample container handling is the inadequate level of safety or an inadequate standard of safety.

### SUMMARY OF THE INVENTION

It is thus an object of the present invention to improve the level of safety in the handling of sample containers.

This object is achieved by the subject matter of the independent claims. Advantageous refinements are the subject matter of the dependent claims which refer back to said independent claims.

According to a first aspect, the invention relates to a sample container handling system. The sample container handling system has a sample container receptacle which has: holding structures which are each configured to hold a respective sample container and which are disposed about a rotation axis, and a base having a support region for supporting the sample containers held by way of the holding structures, wherein the base furthermore has a side that faces away from the support region and at least one through opening which from this side extends to the support region. The sample container handling system furthermore has a support element which is connectable to the base of the sample container receptacle in such a manner so as to receive the latter, wherein the support element has at least one protrusion which, when the support element receives the sample container receptacle, extends through the at least one through opening and for lifting one or more sample containers projects from the support region.

It is thus possible to lift at least one sample container using the sample container handling system and to thereafter simply retrieve said sample container from the sample container receptacle. This is because the at least one protrusion causes lifting of at least one sample container in such a manner that a void by way of which the sample container can be easily gripped and subsequently retrieved from the sample container receptacle is achieved beside said sample container. The at least one protrusion thus forms a type of lift for easily retrieving one or more sample containers.

In other words, by lifting at least one sample container by means of the at least one protrusion, a space beside the sample container thus lifted (i.e. projecting or protruding relative to adjacent sample containers) is achieved, wherein a sample container adjacent to the lifted sample container is not provided in the space. The correspondingly projecting (or protruding) region of the lifted sample container can then be gripped or engaged and retrieved from the sample container receptacle by way of this space or void.

As a result, it is not necessary to utilize an only comparatively narrow space or gap between sample containers that lie close to one another in order for an individual sample container to be retrieved from the sample container receptacle. Consequently, the level of safety when handling, in particular retrieving, the sample containers is improved. This also in particular because an operator, in order to lift the at least one sample container, does not have to lift the latter directly, for example using his/her fingers. Rather, (automated)lifting of one or more sample containers by means of the at least one protrusion can be implemented solely by receiving the sample container receptacle by the support element.

The sample container receptacle preferably has a defined (total) number of holding structures for holding a corresponding number of sample containers, wherein the at least one protrusion, in the state in which the support element receives the sample container receptacle, is suitable for lifting only a number of sample containers that is smaller than the defined number of holding structures such that at least one sample container is lifted relative to the adjacent sample container thereof. In other words, the at least one protrusion is configured in such a manner and/or has such a number of protrusions that, when the maximum possible number of sample containers is held by the holding structures and the support element receives the sample container receptacle, at least one sample container always remains so as to be supported on the support region or, in other words, is not lifted by the at least one protrusion. It is ensured as a result that by lifting one or more of the sample containers by means of the at least one protrusion, a void is always achieved at least beside one sample container, one sample container then being able to be easily gripped and thereafter retrieved by way of this void.

The holding structures can have: first holding structures which are disposed on a first imaginary ring that runs about the rotation axis, and second holding structures which are disposed on a second imaginary ring that runs about the rotation axis. As a result of a configuration of this type of the holding structures, a particularly large number of sample containers can be disposed close to one another in the sample container receptacle. In this way, the throughput of samples can be increased, for example, while simple and safe handling is furthermore guaranteed by interaction between the sample container receptacle and the support element. The imaginary rings can each have different shapes, for example a circular, polygonal, rectangular or square shape. It is preferable for the imaginary rings to each be circular. The radius of the second imaginary ring in this instance is preferably smaller than that of the first imaginary ring.

The at least one through opening can have: at least one first through opening which is disposed and/or configured so as to correspond to the first imaginary ring, and at least one second through opening which is disposed and/or configured so as to correspond to the second imaginary ring. In other words, in a view in the direction of the rotation axis, the first and second holding structures and the at least one first and at least one second through opening can be disposed so as to be at least partially congruent. As a result, it is possible in particular for each of the sample containers to be displaced along a straight line which runs through a first (or second) through opening, on the one hand, and through a first (or second) holding structure, on the other hand, and consequently to be lifted. If the at least one first through opening is configured so as to correspond to the first imaginary ring, said first through opening can be configured in the form of a ring segment or a ring, for example in the form of a slot. If the at least one second through opening is configured so as to correspond to the second imaginary ring, said second through opening can be configured in the form of a ring segment or ring, for example in the form of a slot.

The at least one first through opening can have a plurality of first through openings which are disposed and/or configured so as to correspond to the first imaginary ring. The number of first through openings here preferably corresponds to the number of first holding structures. In another embodiment, the at least one first through opening can also be (only) a single first through opening which is disposed and/or configured so as to correspond to the first imaginary ring. In this way, the single first through opening can be provided for a plurality of or all first holding structures, for example.

The at least one second through opening can have a plurality of second through openings which are disposed and/or configured so as to correspond to the second imaginary ring. The number of second through openings here preferably corresponds to the number of second holding structures. In another embodiment, the at least one second through opening can be (only) a single second through opening which is disposed and/or configured so as to correspond to the second imaginary ring. In this way, the single second through opening can be provided for a plurality of or all second holding structures, for example.

The at least one protrusion preferably has: at least one first protrusion and at least one second protrusion which are disposed in such a manner that, when the support element receives the sample container receptacle, the at least one first protrusion for lifting at least one (first) sample container extends through the at least one first through opening and the at least one second protrusion for lifting at least one (second) sample container extends through the at least one second through opening. In other words, at least one sample container for each imaginary ring projects when the support element receives the sample container receptacle. This results in particularly safe handling of sample containers.

In one embodiment, the at least one through opening can be a single through opening, wherein the at least one protrusion is a single protrusion which is disposed in such a manner that, when the support element receives the sample container receptacle, the protrusion for lifting one or more sample containers extends through the through opening. In other words, only a single through opening by way of which a protrusion of the support element can lift one or more sample containers can be provided for the plurality of holding structures or a plurality of sample containers that can be held by the holding structures. The holding structures, or the sample containers, respectively, here are preferably disposed so as to correspond to a single imaginary ring that runs about the rotation axis.

The support element can have: a base from which the at least one protrusion extends, and at least one lateral wall which extends from the base. When the support element receives the sample container receptacle, the sample container receptacle by way of the side of the base thereof that faces away is supported on the base of the support element and the at least one lateral wall at least partially surrounds the base of the sample container receptacle. As a result, it is ensured that the sample container receptacle is received by the support element in a particularly reliable manner. The at least one lateral wall preferably surrounds the base of the sample container receptacle in such a manner that the sample container receptacle is aligned in a defined manner relative to the at least one protrusion and/or is centered relative to the support element. As a result, the sample container receptacle and the support element, or the at least one lateral wall of the latter, respectively, interact in such a manner that aligning of the at least one through opening relative to the at least one protrusion is simplified. Consequently, the handling of the sample container handling system is simplified.

The base of the sample container receptacle can have a ramp for interacting with the support element, preferably with the lateral wall thereof, and thus for aligning the sample container receptacle relative to the support element. This results in simple handling. Alternatively or additionally, the support element, preferably the lateral wall thereof, can have a ramp for interacting with the base of the sample container receptacle and thus for aligning the sample container receptacle relative to the support element.

The at least one protrusion can be provided so as to be releasable, for example plugged and/or screwed into the base of the support element. As a result, the at least one protrusion can be easily replaced and/or serviced.

The at least one protrusion can be provided so as to be non-releasable, for example in that said at least one protrusion is configured so as to be integral to the base of the support element. The at least one protrusion and the base of the support element can consequently be produced from one casting or be integrally produced. In this way, the at least one protrusion can be easily provided, in particular by way of few production steps.

The at least one protrusion is not restricted to a specific shape. It is preferable for the at least one protrusion to each be configured as a pin, column and/or so as to be circular in cross section, for example to have the shape of a cylinder. Alternatively or additionally, the at least one protrusion can extend in the form of a ring segment or ring, wherein the respective ring shape preferably corresponds to one of the imaginary rings, or to the corresponding imaginary ring, respectively.

The sample container receptacle can have a holding element which is spaced apart from the base of said sample container receptacle, wherein each of the holding structures is at least partially configured in the holding element. As a result, the sample container receptacle, by means of the holding structures which are at least partially configured in the holding element, can particularly readily hold a plurality of sample containers, while a displacement of each one of the sample containers along a direction parallel to the rotation axis is furthermore possible, for example. By virtue of the holding element, the sample container receptacle can form a basket, for example.

The holding structures preferably each have one through opening. In this way, a sample container can be easily guided through the through opening and be held by the latter. To this end, the through opening is preferably configured so as to be somewhat larger than the sample container received by the respective through opening.

Each of the holding structures can be at least partially configured in the support region of the base of the sample container receptacle. This means in particular that the support region is not flat or planar, but is configured so as to be structured, for example, so as to provide a corresponding holding function, for example along a direction transverse to the rotation axis.

Consequently, it can be provided that each of the holding structures is partially configured in the holding element, on the one hand, and partially configured in the support region, on the other hand. Particularly positive holding of the sample containers is the result of a configuration of this type.

The holding structures preferably each have one clearance, wherein the clearances thus formed preferably form the support region of the base. As a result, the sample containers can be particularly well supported and held. The clearances can each be at least partially configured so as to correspond to or be complementary to the base of the sample container. For example, it is conceivable that each of the clearances is at least partially configured so as to be concave.

The at least one through opening can open into the clearances. In the case of a plurality of through openings, it is preferable for each through opening to open into a respective clearance. However, it can also be provided that one through opening opens into a plurality of clearances or a single through opening opens into one of the clearances.

By providing the at least one through opening relative to the clearances in such a manner, it is implemented that, when the support element receives the sample container receptacle, each protrusion for lifting at least one sample container extends through the at least one through opening (thus through a respective or dedicated through opening for example) and into at least one (respective) clearance. The at least one sample container is then lifted relative to the respective clearance, thus then being spaced apart from the latter.

It is preferable for the at least one through opening and the at least one protrusion to be configured and disposed in such a manner that the sample container receptacle, when the at least one protrusion extends through the at least one through opening and for lifting one or more sample containers projects from the support region, is transferred relative to the support element and about the rotation axis to a defined orientation. In this state, a rotation of the sample container receptacle about the rotation axis of the latter is then preferably blocked, or restricted to a defined (small) range (for example tolerance range), by the at least one protrusion which is introduced into the at least one through opening. It is implemented as a result that the sample container receptacle remains in the defined orientation relative to the support element and about the rotation axis.

The defined orientation here can assist in handling the individual sample containers held in the sample container receptacle. For example, it can be ensured by the defined orientation that the sample containers are handled in a specific sequence or only specific sample containers are handled. The handling of the sample containers is thus simplified. This also in particular because an operator does not himself/herself have to find the defined orientation of the sample container receptacle relative to the support element. Rather, the defined orientation is implemented solely by disposal and configuration of the at least one protrusion and of the at least one through opening.

The at least one through opening can be a single through opening or have only a single through opening for each imaginary ring such that the sample container receptacle, when the at least one protrusion extends through the single through opening, is transferred to the defined orientation. The at least one protrusion can have a protrusion which for lifting a sample container is singularly introducible into one through opening of the at least one through opening such that, once introduced, the sample container receptacle is transferred to the defined orientation. It is preferable for the one protrusion to be singularly introducible into the one through opening because only this through opening has a width such as, for example, a diameter that is larger than the width or the diameter of the one protrusion. The one protrusion is preferably the first protrusion, and the one through opening is preferably the first through opening. The one protrusion is preferably not introducible into another through opening of the at least one through opening. The one protrusion is preferably not introducible into the other through opening because the one protrusion has a width such as, for example, a diameter that is larger than the width or the diameter of the other through opening.

The support element can have an identification element, wherein the identification element and a holding structure assigned to the identification element, when the sample container receptacle is transferred to the defined orientation by means of the at least one through opening and by means of at least one protrusion, in a view along the rotation axis are provided on the same radius in terms of the rotation axis. In this way, the identification element is simply (unequivocally) assigned to the corresponding holding structure, or to the corresponding sample container, respectively. This, in a simple manner, results in the individual containers being unequivocally assigned (in particular in a visually identifiable manner). The holding structure assigned to the identification element is preferably provided for holding a sample container, wherein the identification element has items of information pertaining to this sample container and/or to the content of this sample container (thus to the sample, for example).

It is preferable for the identification element to be configured so as to be integral to the support element, for example to the lateral wall or the base of the latter, preferably by way of an engraving, i.e. inscription. In this way, the identification element is preferably provided so as to be non-releasable.

The identification element preferably has a numbering (for example as a numeric code) and/or a barcode (one-dimensional, two-dimensional, QR code, etc.). The numbering here is preferably able to be assigned to a specific sample container.

The sample container receptacle can have a preferably rod-shaped handling structure for handling the sample container receptacle, wherein the handling structure preferably extends from the base of the sample container receptacle and at least partially parallel to the rotation axis and/or is preferably at least partially congruent with the latter. For example, the sample container receptacle by way of the handling structures can be retrieved from the reaction chamber of a pressure container and subsequently be placed into the support element. This can for example take place automatically (preferably using a corresponding gripping mechanism) and/or manually.

The handling structure preferably has a fastening region such as, for example, a flange region, wherein the sample container receptacle by way of the fastening region is able to be fastened, preferably so as to be suspended, in a pressure container, for example in a reaction chamber of the pressure container. For example, the sample container receptacle by way of the handling structure can be hooked into the pressure container, or the reaction chamber, respectively, and thus be fastened therein.

It is preferable for the sample container receptacle by way of the handling structure, in particular by way of the fastening region of the latter, to be able to be moved preferably automatically into and/or out of a pressure container, or a reaction chamber of the pressure container.

According to a further aspect, the invention relates to a system, having: a sample container handling system, as described above, and a pressure container having a reaction chamber as a pressurized chamber for initiating and/or promoting chemical and/or physical pressurized reactions of samples received in the reaction chamber, wherein the sample container receptacle of the sample container handling system is able to be received, or is received, in the reaction chamber.

The sample container receptacle is in particular designed in such a manner that said sample container receptacle can withstand the chemical and/or physical pressurized reactions initiated and/or promoted in the reaction chamber.

### BRIEF DESCRIPTION OF THE DRAWINGS

The invention will be described in an exemplary manner hereunder by means of the figures in which two preferred embodiments of the invention are illustrated. In the drawings:

FIG. 1 shows a schematic sectional view of a first preferred embodiment of the sample container handling system according to the invention, wherein the support element does not receive the sample container receptacle and, as a result, no sample container is lifted by means of the support element;

FIG. 2 shows a schematic sectional view of the embodiment shown in FIG. 1, wherein the support element receives the sample container receptacle and, as a result, a plurality of sample containers are lifted; and

FIG. 3 shows a schematic perspective view of a second preferred embodiment of the sample container handling system according to the invention, wherein the support element receives the sample container receptacle and, as a result, a plurality of sample containers are lifted.

### DETAILED DESCRIPTION OF THE PREFERRED EMBODIMENTS

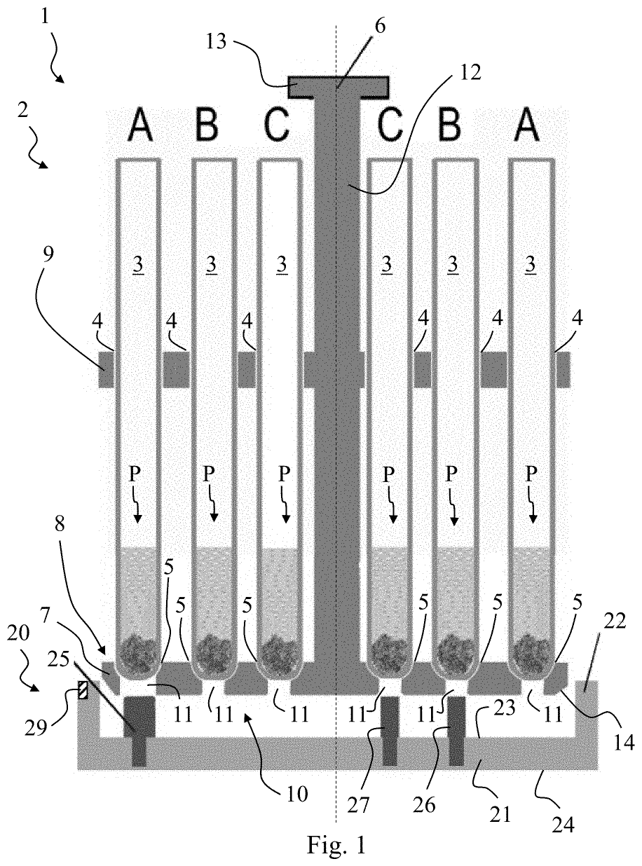

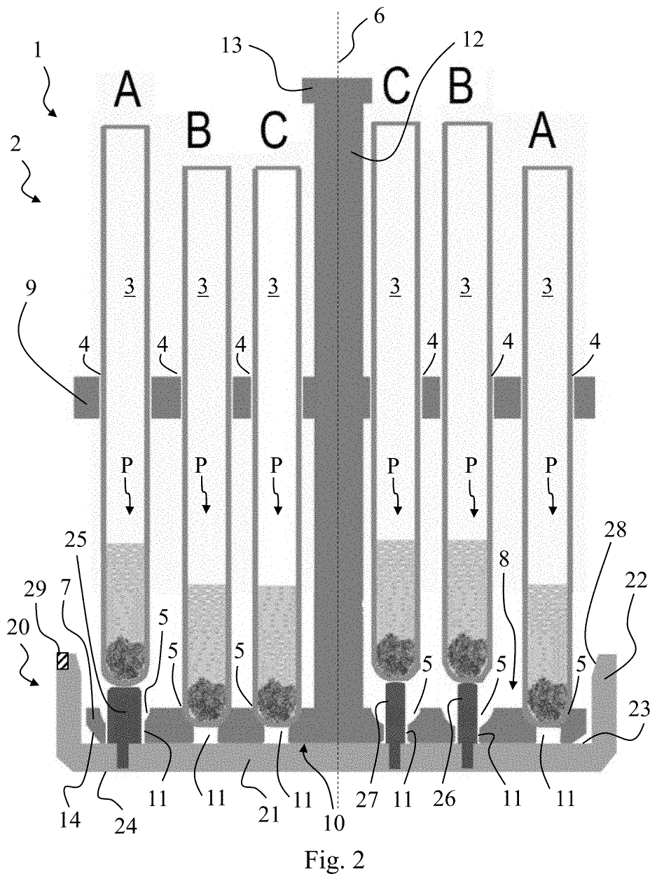

FIGS. 1 and 2 show a sample container handling system 1 according to a first preferred embodiment. The sample container handling system 1 has a sample container receptacle 2 for receiving a plurality of sample containers 3. The sample containers 3 are each configured to receive or to contain a sample P. The sample P can comprise a chemical such as, for example, an acid. Each of the sample containers 3 can be of an elongate configuration and/or be a test tube.

The sample container receptacle 2 has a plurality of holding structures 4, 5 which are each configured to hold a respective sample container 3. The holding structures 4,5 are disposed about a rotation axis 6. The holding structures 4, 5 in the embodiment illustrated in FIGS. 1 and 2 have three groups of holding structures 4, 5, specifically first holding structures 4, 5 which are disposed on a first imaginary (outer) ring A that runs about the rotation axis 6, second holding structures 4, 5 which are disposed on a second imaginary (central)ring B that runs about the rotation axis 6, and third holding structures 4, 5 which are disposed on a third imaginary (inner) ring C that runs about the rotation axis 6. The imaginary rings A, B, C thus have a common center, specifically the rotation axis 6. The rings A, B, C are configured so as to be circular, wherein the radius of the third imaginary ring C is smaller than that of the second imaginary ring B, and the radius of the second imaginary ring B is smaller than that of the first imaginary ring A. In other embodiments, the rings A, B, C can each also have another shape such as, for example, an elliptic, polygonal, rectangular or square shape. The sample containers 3 by way of the holding structures 4, 5 can thus be disposed in a ring arrangement corresponding to the imaginary rings A, B, C. As a result, the sample containers 3 can be disposed so as to be very close together. In other embodiments, it is also conceivable for the holding structures 4, 5 to be disposed only according to one or two of the imaginary rings A, B, C.

The sample container receptacle 2 furthermore has a base 7. The base 7 in turn has a support region 8 on which the sample containers 3 held by way of the holding structures 4, 5 can be supported. Thus, each of the sample containers 3 by way of the respective base thereof, the latter for example being at least partially configured so as to be convex, is supported on the support region 8. Each of the holding structures 4, 5 can be at least partially configured in the support region 8 of the base 7. This means that each of the holding structures 4, 5 has a respective holding part 5 which is configured in the support region 8 of the base 7. The holding part 5 can be configured as a clearance that can receive the respective sample container 3, in particular the base of the latter, for example. The holding part 5 of each holding structure is preferably configured to prevent a movement of the respective sample container 3 in a direction transverse or perpendicular to the rotation axis 6, but to permit a movement in a direction away from the holding part 5 and parallel to the rotation axis 6, for example. The holding part 5, configured in the base 7, can not only serve for holding but also for supporting the respective sample container 3. The holding parts 5 of the holding structures 4, 5 can thus form the support region 8 of the base 7.

However, the invention is not limited to each of the holding structures 4,5 by way of the respective holding part 5 being at least partially configured in the support region 8 of the base 7. In other embodiments it can also be provided that the holding structures are each not configured in the support region 8. The support region 8 in this instance serves exclusively for supporting and thus not for (further)holding of the respective sample container 3. In this instance it can be provided, for example, that the support region 8 is configured so as to be planar or flat, thus extending in only one plane, for example.

The sample container receptacle 2 can furthermore have a holding element 9 which is spaced apart or distal from the base 7 and in which each of the holding structures 4,5 is at least partially configured. With reference to FIGS. 1 and 2, this means that each of the holding structures 4,5 has a respective holding part 4 which is configured in the holding element 9. The holding part 4 of each holding structure is preferably configured to prevent a movement of the respective sample container 3 in a direction transverse or perpendicular to the rotation axis 6, but to permit a movement in a direction away from the base 7 and parallel to the rotation axis 6, for example. As can be seen in FIGS. 1 and 2, each holding part 4 can be configured as a through opening, for example, through which the respective sample container 3 is able to be guided and is thus held by the latter. The through openings 4 preferably extend along the vertical and/or parallel to the rotation axis 6. A sample container 3 can thus be guided through a respective through opening 4 or be inserted into the latter, so as to subsequently be supported on the support region 8 and preferably be held by the holding part 5. Each of the holding structures 4, 5, by way of the respective holding part 4 thereof and/or the respective holding part 5 thereof, is preferably configured to hold a sample container 3 so as to be substantially parallel to the rotation axis 6.

The holding element 9 is not limited to a specific design embodiment. As is illustrated in FIGS. 1 and 2, the holding element 9 can be configured in the form of a disk, for example. The holding element 9 preferably has a side that faces the support region 8 and a side that faces away from the support region 8, wherein the through openings 4 preferably each extend from the former side to the latter side. The holding element 9 can be, for example, a perforated disk which is formed by the plurality of through openings 4.

The base 7 furthermore has a side 10 that faces away from the support region 8. Moreover, the base 7 has a plurality of through openings 11 which each extend from the side 10 to the support region 8. The through openings 11 in the embodiment illustrated in FIGS. 1 and 2 are disposed so as to correspond to the imaginary rings A, B, C. This means that, when viewed in a plan view of the system 1, the holding structures 4, 5 are at least partially congruent with the through openings 11. In other words, each through opening 11 is preferably disposed so as to be in alignment with a respective holding structure 4, 5, thus for example a respective holding part 4 and/or holding part. It is preferable for a respective through opening 11 to be provided for each holding structure 4,5. However, it can also be provided that a respective through opening 11 is provided for each group of holding structures 4, 5. Each of the through openings 11 extends in such a manner that there can be access to a corresponding sample container 3 which is supported on the support region 8 by way of the respective through opening 11. It can thus be provided, for example, that each through opening 11 opens into a respective or corresponding clearance 5.

The through openings 11 in the embodiment illustrated in FIGS. 1 and 2 have three (groups of) through openings 11, specifically one or more first through openings 11 which are disposed so as to correspond to the first imaginary ring A, one or more second through openings 11 which are disposed so as to correspond to the second imaginary ring B, and one or more third through openings 11 which are disposed so as to correspond to the third imaginary ring C. In other embodiments it can however also be provided that the through openings 11 are disposed only according to the first imaginary ring A and/or second imaginary ring B.

The sample container receptacle 2 can furthermore have a preferably rod-shaped handling structure 12 (for example in the form of a guide rod) by way of which the sample container receptacle 2 can be handled, for example for the latter to be inserted into a pressure container or a reaction chamber of the pressure container or to be retrieved from the latter. As illustrated in FIGS. 1 and 2, the handling structure 12 can for example extend so as to be parallel to the rotation axis 6 and/or be congruent with the rotation axis 6. This means that, by rotating the handling structure 12 about the axis thereof, the sample container receptacle 2 can be rotated about the rotation axis 6. The handling structure 12 preferably has a fastening region 13 (for example in the form of a flange region) by way of which the sample container receptacle 2 can be fastened in a pressure container or a reaction chamber of the pressure container, for example by way of a suspension mechanism. The holding element 9 is preferably held by the handling structure 12 or fastened to the latter. When one or more sample containers 3 are held by way of the handling structures 4, 5, said sample containers 3 preferably extend parallel to the handling structure 12.

The sample container handling system 1 furthermore has a support element 20 which is connectable to the base 7 of the sample container receptacle 2 in such a manner so as to receive the sample container receptacle 2. In order for the sample container receptacle 2 to be reliably received by the support element 20, the latter can be configured in the form of a bowl, i.e. be a bowl element, for example. It is preferable for the support element 20 to have a shape which at least partially corresponds or is complementary to the base 7. As can be seen in FIGS. 1 and 2, the support element 20 can have a base 21 and at least one lateral wall 22 which extends away from the base 21. The base 21 is configured such that the base 7 of the sample container receptacle 2 by way of the side to thereof can be supported on the base 21. To this end, the base 21 preferably has a front side or supporting side 23 on which the side 10 can be supported. The base 21 furthermore has a rear side 24 which faces away from the supporting side 23 and by way of which the base 21, and thus the support element 20, can be supported on a surface, for example of a table, or be fastened to said surface.

The support element 20 has a plurality of protrusions 25, 26, 27 which are each provided for lifting a sample container 3. In other embodiments, the support element 20 can also have more or fewer protrusions, for example only one protrusion. The latter in this instance can be provided for lifting one or a plurality of sample containers 3. Each protrusion is configured to lift a single sample container 3 or a plurality of sample containers 3. In the embodiment illustrated in FIGS. 1 and 2, a first protrusion 25 is provided for lifting a sample container 3 which is disposed according to the first imaginary ring A. Furthermore, the protrusions in this embodiment have: a second protrusion 26 for lifting a sample container 3 which is disposed according to the second imaginary ring B and a third protrusion 27 for lifting a sample container 3 which is disposed according to the third imaginary ring C.

The protrusions 25, 26, 27 can be provided so as to be releasable. This can for example be implemented in that one or more of the protrusions 25, 26, 27 are plugged and/or screwed into the base 21. In other embodiments, the protrusions 25, 26, 27 can be configured so as to be integral to the base 21. The protrusions 25, 26, 27 are each not limited to a specific configuration. It is preferable for the protrusions 25, 26, 27 to each be configured as a column and/or circular in cross section, thus to have the shape of a cylinder, for example. The protrusions 25, 26, 27 in terms of a central axis of the support element 20 can be disposed on the same diameter or on different diameters.

It is preferable for the central axis of the support element 20, when viewed in a cross section, to be provided between the protrusion 25, on the one hand, and the protrusions 26, 27, on the other hand. For example, the protrusions 25, 26, 27 can be provided so as to be asymmetrical in terms of the central axis of the support element 20. It is preferable for the central axis of the support element 20 to be parallel to the rotation axis 6 of the sample container receptacle 2 (and preferably to be congruent with the rotation axis 6) when the sample container receptacle 2 is received by the support element 20.

Illustrated in FIG. 1 is a state of the sample container handling system 1 in which the sample container receptacle 21 has not yet been received by the support element 20. The base 7 of the sample container receptacle 2 is spaced apart from the base 21, or from the side 23 of the latter, respectively, specifically in such a manner that none of the sample containers 3 is lifted by the protrusions 25, 26, 27. In particular, the protrusions 25, 26, 27 are not introduced into the through openings 11. Each of the sample containers 3 by way of the respective lower end thereof thus is supported on the support region 8. As a result, the openings or upper ends of the sample containers 3 are disposed so as to be substantially in a common plane. In this state it is difficult to retrieve one or more of the sample containers 3 from the sample container receptacle 2. This in particular because no adequate void, by way of which at least one of the sample containers 3 can be gripped and thereafter retrieved from the respective holding structure 4, 5, exists as a result of the sample containers 3 being disposed close together in the sample container receptacle 2.

In order for one or more of the sample containers 3 to be easily retrieved from the sample container receptacle 2, the sample container handling system 1 is therefore transferred to the state illustrated in FIG. 2. The sample container receptacle 2 in the process is moved toward the support element 20 so as to be received by the latter. In the process, each of the protrusions 25, 26, 27 passes through a respective through opening 11, as a result of which at least one sample container 3 on each of the imaginary rings A, B, C is lifted. In the state shown according to FIG. 2, in which the support element 20 receives the sample container receptacle 2, each of the protrusions 25, 26, 27 thus extends through the respective through opening 11 and, as a result, projects from the support region 8. As a result of this projecting action (i.e. protruding action), the respective sample container 3 can no longer be supported on the support region 8. Rather, it is implemented by the projecting action that the respective sample container 3 is moved relative to the support region 8 and thus moved away from the latter. The respective sample container 3 in the process moves through the respective through opening 4 and parallel to the rotation axis 6. In this way, the sample container 3 thus lifted projects from the plane in which the openings or upper ends of the sample containers 3 were previously provided. In other words, a void into which no adjacent sample container 3 extends is achieved beside the upper end of the respective lifted sample container 3, said upper end comprising the opening and/or facing away from the base 8. The respective lifted sample container 3 can be easily gripped and retrieved from the sample container receptacle 2 by way of this void. And this in particular without an only small gap between adjacent sample containers 3 having to be utilized, as illustrated in FIG. 1.

For example, it can be provided that only one sample container 3 for each imaginary ring A, B, C is lifted in relation to adjacent sample containers 3. This is already adequate for easy handling of the sample containers 3. This is because as soon as the respective lifted sample container 3 has been retrieved from the sample container receptacle 2, a further void, by way of which the sample containers 3 that are adjacent to the lifted (and already retrieved) sample container 3 can be successively retrieved from the sample container receptacle 2, is provided by the space that has been achieved by the retrieval of the lifted sample container 3.

As illustrated in FIG. 2, in the state in which the support element 20 receives the sample container receptacle 2, it is preferable for the latter by way of the side 10 thereof to be supported on the base 21 of the support element 20. The at least one lateral wall 22 in this instance here is provided such that said at least one lateral wall 22 at least partially surrounds the base 7. The lateral wall 22 here can in particular be provided in such a manner that the sample container receptacle 2, in particular the through openings 11 thereof, is aligned in a defined manner relative to the protrusions 25, 26, 27. This above all helps an operator of the sample container handling system 1 in introducing the protrusions 25, 26, 27 into the corresponding through openings 11. The lateral wall 22 can also have the effect that the sample container receptacle 2 is centered relative to the support element 20. In order for the sample container receptacle 2 to be aligned relative to the support element 20 in a particularly advantageous, thus particularly simple, manner, the base 7 of the sample container receptacle 2 can have a ramp 14. The ramp 14 here is provided such that the ramp 14, when connecting the sample container receptacle 2 to the support element 20, can impact the base 20 such as, for example, the lateral wall 22 thereof and the sample container receptacle 2 as a result is driven in the direction of the central axis of the support element 20. In such a (centered) position, it can suffice to rotate the sample container receptacle 2 about the rotation axis 6 thereof and/or to move said sample container receptacle 2 along the rotation axis 6 (for example by gravity), in order for the protrusions 25, 26, 27 to be introduced into the corresponding through openings 11. This consequently results in particularly easy handling. Alternatively or additionally, the support element 20, for example the lateral wall 22 thereof, can have a ramp 28. The ramp 28 in this instance is provided such that the latter, when connecting the sample container receptacle 2 to the support element 20, can impact the sample container receptacle 2, for example the base 7 or ramp 14 thereof, as a result of which the sample container receptacle 2 is driven in the direction of the central axis of the support element 20.

It is preferable for the sample container receptacle 2, by way of the protrusions 25, 26, 27 and the through openings 11, to be able to be transferred relative to the support element 20 and about the rotation axis 6 to a defined orientation. As can be seen in FIGS. 1 and 2, this can take place, for example, in that the protrusion 25 is correspondingly disposed and/or configured in terms of the through openings 11. This preferably takes place in such a manner that the protrusion 25 is singularly introducible into a specific through opening 11, for example singularly into one of the through openings 11 provided according to the first imaginary ring A. Accordingly, the protrusion 25 is not introducible into other through openings 11, for example into the remaining through openings 11 provided according to the first imaginary ring A and/or those through openings 11 provided according to the imaginary rings B, C, for example owing to a larger and/or other shape. It is preferable for the specific through opening 11 to have a size or width of such type that the protrusion 25 is introducible only into this through opening 11. The state in which the protrusions 25, 26,27 are each provided in a matching through opening n is provided as soon as one or more of the sample containers 3 has/have been lifted, as illustrated in FIG. 2 for example. In this way, the state in which the defined orientation is provided can be easily identified. In this state specifically, at least one sample container 3 is lifted.

It is preferable for the support element 20 to have an identification element 29 such as, for example, a numbering and/or a barcode. The identification element 29 can be provided on the lateral wall 22. In other embodiments, the identification element 29 can also be provided on the base 21, for example on a peripheral region of the base 21. The identification element 29 is able to be assigned to one or more holding structures 4, 5 and/or to one or more sample containers 3, which are provided on the same radius in terms of the rotation axis 6. The identification element 29 here is provided on the support element 20 such that the identification element 29, when the sample container receptacle 2 by means of the through openings 11 and the protrusions 25, 26, 27 has been transferred to the defined orientation as described above, (in plan view, thus when viewed in the direction of the rotation axis 6) is provided on the same radius as the holding structure(s) or sample container(s), respectively, assigned to the identification element 29. In this way, an operator of the sample container handling system can easily identify that the identification element 29 is assigned to exactly this/these holding structure(s) and/or sample container(s). For example, the identification element 29 contains items of information pertaining to the corresponding sample container 3 and/or to the content of this sample container 3. The identification element 29 can be configured so as to be integral to part of the support element 20 (for example the base 21 and/or the lateral wall 22), for example. Such an integral configuration can be implemented by an engraving, for example. In other embodiments, the identification element 29 can be provided on the support element 20 by way of a fastening means (for example a materially integral connection, preferably in the form of an adhesive tape).

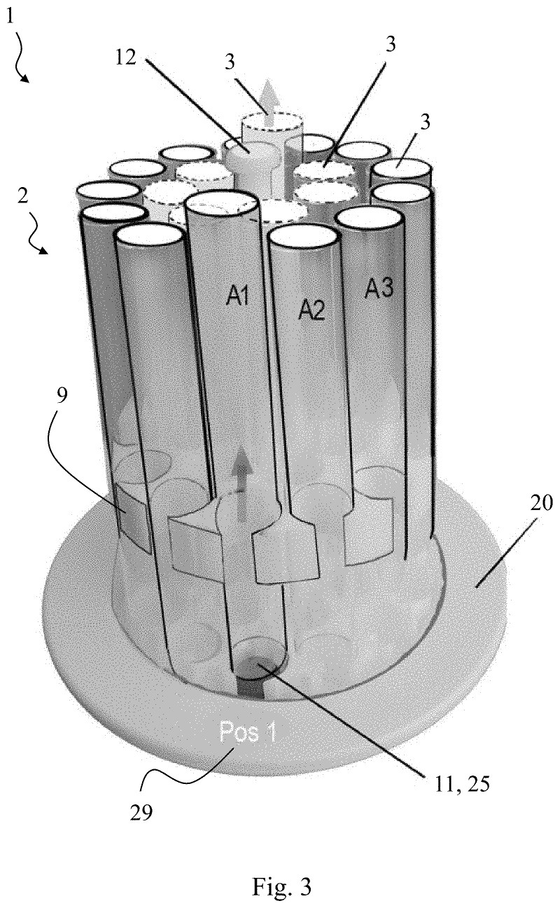

Illustrated in an exemplary manner in FIG. 3 is a sample container handling system 1 according to a second preferred embodiment. It can be seen that the sample container handling system 1 according to the second preferred embodiment differs from the first preferred embodiment only in that the third handling structures 4, 5, which are disposed so as to correspond to the third imaginary ring C, are absent. Accordingly, the sample container receptacle 2 does not have the at least one third through opening u which is provided for the sample containers 3 disposed according to the third imaginary ring C. Consequently, the at least one third protrusion 27 of the support element 20 is also not required and thus not provided in this embodiment. Otherwise, the second preferred embodiment corresponds substantially to the first preferred embodiment such that the description pertaining to the first preferred embodiment applies correspondingly to the second preferred embodiment.

The invention here is not limited to the features described above. In particular, all features described above can be combined with one another in an arbitrary manner.

1. Sample container handling system (1), having:
a sample container receptacle (2), having:
holding structures (4,5) which are each configured to hold a respective sample container (3) and which are disposed about a rotation axis (6), and
a base (7) having a support region (8) for supporting the sample containers (3) held by way of the holding structures (4, 5), wherein the base (7) furthermore has a side (10) that faces away from the support region (8) and at least one through opening (11) which from this side (10) extends to the support region (8); and
a support element (20) which is connectable to the base (7) of the sample container receptacle (2) in such a manner so as to receive the latter, wherein the support element (20) has at least one protrusion (25, 26, 27) which, when the support element (20) receives the sample container receptacle (2), extends through the at least one through opening (11) and for lifting one or more sample containers (3) projects from the support region (8).

2. Sample container handling system (1) according to claim 1, wherein the sample container receptacle (2) has a defined number of holding structures (4,5) for holding a corresponding number of sample containers (3), wherein the at least one protrusion (25, 26, 27), in the state in which the support element (20) receives the sample container receptacle (2), is suitable for lifting only a number of sample containers (3) that is lower than the defined number of holding structures (4, 5), so that at least one sample container (3) is lifted relative to the adjacent sample container (3) thereof.

3. Sample container handling system (1) according to claim 1, wherein the holding structures (4, 5) have: first holding structures (4, 5) which are disposed on a first imaginary ring (A) that runs about the rotation axis (6), and second holding structures (4,5) which are disposed on a second imaginary ring (B) that runs about the rotation axis (6), wherein the imaginary rings (A, B) are each preferably circular and the radius of the second imaginary ring (B) is preferably smaller than that of the first imaginary ring (A).

4. Sample container handling system (1) according to claim 3, wherein the at least one through opening (11) has: at least one first through opening (11) which is disposed and/or configured so as to correspond to the first imaginary ring (A), and at least one second through opening (11) which is disposed and/or configured so as to correspond to the second imaginary ring (B).

5. Sample container handling system (1) according to claim 4, wherein the at least one first through opening (11) has a plurality of first through openings (11) which are disposed and/or configured so as to correspond to the first imaginary ring (A).

6. Sample container handling system (1) according to claim 4, wherein the at least one first through opening (11) is a single first through opening (11) which is disposed and/or configured so as to correspond to the first imaginary ring (A).

7. Sample container handling system (1) according to claim 4, wherein the at least one second through opening (11) has a plurality of second through openings (11) which are disposed and/or configured so as to correspond to the second imaginary ring (B).

8. Sample container handling system (1) according to claim 4, wherein the at least one second through opening (11) is a single second through opening (11) which is disposed and/or configured so as to correspond to the second imaginary ring (B).

9. Sample container handling system (1) according to claim 4, wherein the at least one protrusion (25, 26, 27) has: at least one first protrusion (25) and at least one second protrusion (26) which are disposed in such manner that, when the support element (20) receives the sample container receptacle (2), the at least one first protrusion (25) for lifting at least one sample container (3) extends through the at least one first through opening (11), and the at least one second protrusion (26) for lifting at least one sample container (3) extends through the at least one second through opening (11).

10. Sample container handling system (1) according to claim 1, wherein the at least one through opening is a single through opening, and wherein the at least one protrusion is a single protrusion which is disposed in such a manner that, when the support element (20) receives the sample container receptacle (2), the protrusion for lifting one or more sample containers extends through the through opening.

11. Sample container handling system (1) according to claim 1, wherein the support element (20) has: a base (21) from which the at least one protrusion (25, 26, 27) extends, and at least one lateral wall (22) which extends from the base (21), wherein said at least one lateral wall (22), when the support element (20) receives the sample container receptacle (2), by way of the side (10) of said at least one lateral wall (22) that faces away from the support region (8) is supported on the base (21) of the support element (20) and the at least one lateral wall (22) at least partially surrounds the base (7) of the sample container receptacle (2), preferably in such a manner that the sample container receptacle (2) is aligned in a defined manner relative to the at least one protrusion (25, 26, 27) and/or is centered relative to the support element (20).

12. Sample container handling system (1) according to claim 1, wherein the base (7) of the sample container receptacle (2) has a ramp (14) for interacting with the support element (20), preferably with the lateral wall (22) of the latter, and thus for aligning the sample container receptacle (2) relative to the support element (20).

13. Sample container handling system (1) according to claim 1, wherein the support element (20), preferably the lateral wall (22) thereof, has a ramp (28) for interacting with the base (7) of the sample container receptacle (2) and thus for aligning the sample container receptacle (2) relative to the support element (20).

14. Sample container handling system (1) according to claim 1, wherein the at least one protrusion (25, 26, 27) is provided so as to be releasable, for example plugged and/or screwed into the base (21) of the support element (20).

15. Sample container handling system (1) according to claim 1, wherein the at least one protrusion (25, 26, 27) is provided so as to be non-releasable, for example configured so as to be integral to the base (21) of the support element (20).

16. Sample container handling system (1) according to claim 1, wherein the sample container receptacle (2) has a holding element (9) which is spaced apart from the base (7) of said sample container receptable (2), wherein each of the holding structures (4, 5) is at least partially configured in the holding element (9).

17. Sample container handling system (1) according to claim 1, wherein the holding structures (4,5) each have one through opening (4).

18. Sample container handling system (1) according to claim 1, wherein each of the holding structures (4,5) is at least partially configured in the support region (8) of the base (7) of the sample container receptacle (2).

19. Sample container handling system (1) according to claim 1, wherein the holding structures (4,5) each have one clearance (5), and wherein the clearances (5) preferably form the support region (8) of the base (7).

20. Sample container handling system (1) according to claim 19, wherein the at least one through opening (11) opens into the clearances (5) such that the at least one protrusion (25, 26 27), when the support element (20) receives the sample container receptacle (2), for lifting at least one sample container (3) extends through the at least one through opening (11) and into at least one corresponding clearance (5).

21. Sample container handling system (1) according to claim 1, wherein the at least one through opening (11) and the at least one protrusion (25, 26, 27) are configured and disposed in such a manner that the sample container receptacle (2), when the at least one protrusion (25, 26, 27) extends through the at least one through opening (11) and for lifting one or more sample containers (3) projects from the support region (8), is transferred relative to the support element (20) and about the rotation axis (6) to a defined orientation.

22. Sample container handling system (1) according to claim 21, wherein the at least one through opening (11) is a single through opening or has only a single through opening (11) for each imaginary ring (A, B, C) such that the sample container receptacle (2), when the at least one protrusion (25, 26, 27) extends through the single through opening or the single through openings (11), is transferred to the defined orientation.

23. Sample container handling system (1) according to claim 21, wherein the at least one protrusion (25, 26, 27) has one protrusion (25) which for lifting a sample container (3) is singularly introducible into one through opening (11) of the at least one through opening (11) such that, once introduced, the sample container receptacle (2) is transferred to the defined orientation, wherein the one protrusion (25) is preferably the first protrusion (25), and wherein the one through opening (11) is preferably the first through opening (11).

24. Sample container handling system (1) according to claim 21, wherein the support element (20) has an identification element (29), wherein the identification element (29) and a holding structure (4,5) assigned to the identification element (29), when the sample container receptacle (2) is transferred to the defined orientation, in a view along the rotation axis (6) are provided on the same radius in terms of the rotation axis (6).

25. Sample container handling system (1) according to claim 24, wherein the holding structure (4,5) assigned to the identification element (29) is provided for holding a sample container (3) and the identification element (29) has items of information pertaining to this sample container (3) and/or the content (P) of this sample container (3).

26. Sample container handling system (1) according to claim 24, wherein the identification element (29) is configured so as to be integral to the support element (20), for example to the base (21) or lateral wall (22) thereof, for example by way of an engraving.

27. Sample container handling system (1) according to claim 24, wherein the identification element (29) has a numbering and/or a barcode.

28. Sample container handling system (1) according to claim 1, wherein the sample container receptacle (2) has a preferably rod-shaped handling structure (12) for handling the sample container receptacle (2), wherein the handling structure (12) preferably extends from the base (7) of the sample container receptacle (2) and at least partially parallel to the rotation axis (6) and/or is preferably at least partially congruent with the latter.

29. Sample container handling system (1) according to claim 28, wherein the handling structure (12) has a fastening region (13) such as, for example, a flange region, wherein the sample container receptacle (2) by way of the fastening region (13) is able to be fastened, preferably so as to be suspended, in a pressure container.

30. System, having:
a sample container handling system (1) according to claim 1, and
a pressure container having a reaction chamber as a pressurized chamber for initiating and/or promoting chemical and/or physical pressurized reactions of samples received in the reaction chamber,
wherein the sample container receptacle (2) of the sample container handling system (1) is able to be received, or is received, in the reaction chamber.
